(19) United States
(12) Patent Application Publication
(10) Pub. No.: US 2026/0127733 A1
(43) Pub. Date: May 7, 2026

(54) METHOD, DEVICE AND SYSTEM FOR DETECTING A SHAPE DEVIATION

(71) Applicant: Carl Zeiss AG, Oberkochen (DE)

(72) Inventors: Matthias Karl, Koenigsbronn (DE); Jan Henrik Fitschen, Hamburg (DE)

(21) Appl. No.: 19/427,874

(22) Filed: Dec. 19, 2025

Related U.S. Application Data
(63) Continuation of application No. PCT/EP2024/067017, filed on Jun. 19, 2024.

(30) Foreign Application Priority Data
Jun. 23, 2023 (DE) 10 2023 116 637.9

(51) Int. Cl. G06T 7/00; G06T 7/60; G06T 7/70; G06V 20/64

(52) U.S. Cl. CPC G06T 7/001; G06T 7/60; G06T 7/70; G06V 20/647; G06T 2207/30244

(57) ABSTRACT

In order to recognize a shape deviation of an inspection object from a three-dimensional target geometry in three dimensions, three-dimensional, back-projections onto the three-dimensional target geometry are determined by at least one processing circuit, wherein a back-projection onto at least a part of the three-dimensional target geometry is determined for each of several two-dimensional images of the inspection object. The back-projections determined for the several two-dimensional images are compared by the at least one processing circuit in order to recognize the shape deviation.

### CROSS-REFERENCE TO RELATED APPLICATIONS

This application is a continuation application of international patent application PCT/EP2024/067017, filed June 19, 2024, designating the United States and claiming priority from German application 102023116 637.9, filed June 23, 2023, and the entire content of both applications is incorporated herein by reference.

### TECHNICAL FIELD

The disclosure relates to methods, apparatuses and systems for recognizing a shape deviation using electromagnetic radiation. In particular, the disclosure relates to methods, apparatuses and systems for image-based recognition of a deviation between a three-dimensional geometry of an inspection object and its three-dimensional target geometry.

### BACKGROUND

Recognizing a shape deviation between an actual three-dimensional (3-D) geometry of an inspection object and its 3-D target geometry has various fields of application, for example in quality control.

Recognizing a shape deviation using electromagnetic radiation and optical techniques in particular is attractive for various reasons, for example on account of the attainable speed and on account of its contactless manner of operation.

For example, a deviation between target and actual geometries may be effected by the determination of the actual geometry. Methods using structured illumination allow the determination of the actual geometry but require well-defined illumination patterns and knowledge about the illumination patterns. A surface may be measured with great accuracy using the techniques disclosed in EP 2321614 B1, but a light source that usually cannot be handled manually is required to this end.

DE 102020134680 A1 discloses a quality control method, in which images may be captured using a mobile capture device and subsequently be evaluated. However, the application of this quality control technique may entail comparatively large outlay as regards the configuration for the quality control to be performed, for instance the definition of a reference point and the definition of the target geometry. In order to obtain detailed information at the component level during this inspection, it is necessary for the target geometry to be available in such a format that individual components may be removed and/or addressed on an individual basis. However, this requirement is not met in some fields of application. The result of the inspection may be subjected to undesirably strong influences, for example as a result of the texture of the inspection object.

Thus, the technology still needs improved methods, apparatuses and systems for recognizing a shape deviation.

### SUMMARY

It is an object of the disclosure to provide improved methods, apparatuses and systems for recognizing a shape deviation. In particular, a problem addressed is that of specifying such methods, apparatuses and systems that may be operated with little setup complexity and can be used for various object geometries. In this context, it is optionally desirable to provide methods, apparatuses and systems in which necessary data acquisition on the inspection object may be carried out in a simple manner.

The above object is achieved via various embodiments of the disclosure.

According to an aspect, the disclosure relates to a method for recognizing a shape deviation of an inspection object from a 3-D target geometry of the inspection object in three dimensions (3-D). The method includes: receiving two-dimensional, 2-D, images of the inspection object by at least one processing circuit, determining several back-projections onto the 3-D target geometry by the at least one processing circuit, wherein a back-projection onto at least a part of the 3-D target geometry is determined for each of several 2-D images of the inspection object, and using the at least one processing circuit to perform a comparison of the back-projections determined for the several 2-D images in order to recognize the shape deviation.

Various technical effects and advantages are obtained by the method. The method is based on the use of several 2-D images in combination with the 3-D target geometry. This allows the recognition of inconsistencies that indicate a deviation from the 3-D target geometry. In this context, there is no need to reconstruct the actual geometry of an inspection object in 3-D in order to detect deviations from the 3-D target geometry. Instead, the back-projections of at least two and advantageously more than two 2-D images onto the 3-D target geometry are used in order to recognize both the presence and the location of a shape deviation between the actual geometry and the 3-D target geometry of the inspection object. A technical advantage of the method consists in the latter operating on the basis of 2-D images that may be captured using a conventional camera, for example a camera integrated in a mobile device. A further technical advantage lies in the fact that structured illumination is not required. Hence, staff without special training may also perform the 2-D image data acquisition.

In comparison with conventional techniques, the method offers good robustness vis-à-vis different illumination conditions and/or different surface textures. Only the outer 3-D envelope of the inspection object is required as 3-D target geometry. Individual components in the 3-D target geometry need not be separately addressable. A digitized 3-D object (that is, a shape model without texture) may also be used as 3-D target geometry. This opens up new fields of application.

In comparison with conventional techniques, the method also offers a good ratio of ascertained information content in relation to the time required for the data acquisition and evaluation of the 2-D images. In particular, time-efficient matching between the 3-D target geometry and the actual geometry captured in the 2-D images is rendered possible. The fact that the setup outlay is low also contributes to the time efficiency. Complex setup steps for the data acquisition as required in numerous conventional methods are rendered superfluous in the method according to the disclosure.

The comparison may be carried out for each of several different facets of the 3-D target geometry.

This allows a potential deviation to be recognized for each of the several different facets of the 3-D target geometry. The comparison may be carried out for facets that are depicted in at least two 2-D images of the 2-D images received.

On the basis of the comparison, the at least one processing circuit can perform a spatially resolved ascertainment of the regions in which an outer envelope of the inspection object deviates from an outer envelope of the 3-D target geometry.

The effect thereof is that only the outer envelope of the target geometry of the inspection object is required as the 3-D target geometry. In particular, the 3-D target geometry may be a 3-D target geometry of only the outer envelope of the inspection object. This renders efficient processing possible. Moreover, the method may be applied to inspection objects that for example only have information about the outer envelope available.

The method may further include a provision of an output on the basis of the recognized shape deviation.

This allows the result of the shape deviation recognition to be rendered usable. The result of the shape deviation recognition may be used in various ways, for example for the output to a human operating staff, for the output of a warning if a shape deviation is recognized or for direct influence on an industrial process, for example a manufacturing or servicing process.

The output may include a spatially resolved visualization of the recognized shape deviation.

The location of the recognized shape deviation in relation to the 3-D target geometry or the actual geometry can be easily rendered visible as a result. This facilitates locating the shape deviation and a possible rectification of the cause.

The several back-projections may be determined on the basis of poses of an image capture device when capturing the 2-D images. The method may further include an ascertainment of the poses by the at least one processing circuit.

As a result, the method allows the shape deviation to be inspected with particularly simple capture of the 2-D images. The poses may be ascertained automatically by the at least one processing circuit, for example in image-based fashion. The 2-D images need not be captured at specific positions and with specific directions of the image capture device relative to the inspection object, but this is possible.

In order to ascertain a pose for a 2-D image, the 2-D image, the 3-D target geometry and camera parameters of an image capture device used to capture the 2-D image can be used.

This allows the determination of the pose (that is, the three translational coordinates and the three rotational coordinates of the image capture device relative to the inspection object) in image-based fashion. The camera parameters may be determined once and stored in non-transitory fashion for any desired image capture device that is subsequently used for the shape deviation inspection.

In an alternative to that or in addition, the pose for a 2-D image can be ascertained using sensor data assigned to the 2-D image.

This allows sensor data to be used to ascertain the pose. The sensor data may include sensor data acquired by sensors integrated in the image recording device (for example, acquired by a global navigation satellite system (GNSS) or an acceleration sensor). In an alternative to that or in addition, the sensor data may include sensor data acquired and provided by a sensor system (for example, a tracking system) that is separate to the image recording. As a result, the pose determination, which is subsequently used to determine the back-projections, can be implemented even more accurately. Possible ambiguities can be resolved using the sensor data.

The method may further include: reading 3-D target geometry data from a memory system, and creating a scaled model of an outer envelope of the 3-D target geometry on the basis of the read 3-D target geometry data by the at least one processing circuit, wherein the back-projections are determined on the basis of the scaled model of the outer envelope.

This allows suitable scaling to be performed before the back-projections are determined. For example, linear scaling may be implemented in such a way that details that are no longer resolvable in the 2-D images in any case are no longer contained in the scaled model. Hence, the scaling may be implemented in a manner dependent on a resolution in the 2-D images and the read 3-D target geometry data.

The method may further include: selecting the several 2-D images from the received 2-D images by the at least one processing circuit.

This allows the back-projected 2-D images to be selected automatically. The several back-projected 2-D images may be selected automatically from for example a succession of 2-D images captured in sequence (for example in a video sequence) by an image capture device.

The several 2-D images may be selected in such a way that each facet of the 3-D target geometry for which a deviation should be detectable is visible in several back-projected 2-D images.

This can ensure that possible inconsistencies between the back-projections onto the corresponding facet that emerge from a deviation between the actual geometry and the 3-D target geometry can be detected for each relevant facet.

The several 2-D images may be selected on the basis of the 3-D target geometry and poses of the image capture device when capturing the received 2-D images. As explained above, the poses may be ascertained automatically in this case, for example in image-based fashion and/or by using sensor data.

As a result, the processing circuit can make a simple automatic selection from the received 2-D images on the basis of objective criteria.

The method may further include: receiving additional 2-D images by the at least one processing circuit, and comparing further back-projections onto the 3-D target geometry determined from the additional 2-D images in order to improve the recognition of the shape deviation.

This allows the detection of the shape deviation to be continued when the additional 2-D images become available. For example, this may be the case if the image capture is continued for inspection purposes while the already available 2-D images are evaluated in parallel with the continued image capture.

The method may further include: creating control data or control signals by the at least one processing circuit for the purpose of controlling or guiding a capture of the 2-D images.

This can ensure that at least two 2-D images are available for back-projection purposes for each facet for which a deviation should be recognizable. The work in situ on the inspection object is simplified by virtue of the image capture being controlled or guided.

The at least one processing circuit can use the 3-D target geometry for the creation of the control data or control signals.

This can automatically ensure that at least two 2-D images are available for back-projection purposes for each facet for which a deviation should be recognizable. The work in situ on the inspection object is simplified further.

The method may further include capturing the 2-D images using a camera and making the captured 2-D images available for the at least one processing circuit. The method may further include bringing about a relative movement between the camera and the inspection object in order to obtain images from several different perspectives for the evaluation.

As a result, the images required to recognize the shape deviation may be obtained from different perspectives.

The camera may be provided in a movable image capture device. In the methods, the movable image capture device may be moved relative to the inspection object in order to obtain 2-D images from several different perspectives for the evaluation.

This allows image recordings to be obtained from different perspectives by virtue of the image capture device with the camera being moved relative to the inspection object.

The camera may be provided in an image capture device that takes the form of a handheld device. In the method, the handheld device may be moved relative to the inspection object in order to obtain the 2-D images from several different perspectives for the evaluation.

This allows the 2-D images to be captured easily, for example by virtue of the handheld device being moved relative to the inspection object by a human user or by way of using controllable actuators.

The method may include transferring the 2-D images from the camera to the at least one processing circuit. The transfer may be wired or wireless, for example via a communications interface.

This allows the evaluation of the 2-D images for the recognition of the shape deviation to be carried out by a computing device that differs from the handheld device.

Prior to the transfer, the method may include a preprocessing or pre-evaluation of images captured by the camera.

This allows a preprocessing or pre-evaluation to be effected in a handheld device, for example, or in any other mobile device. The pre-processed data may then be transferred as intermediate results of the processing to the computing device.

This allows the evaluation of the 2-D images for the recognition of the shape deviation to be carried out in part in the handheld device and in part in the computing device.

The handheld device may include a wireless communications interface. For example, the handheld device may be configured as a communications terminal, for example, as a smartphone.

For example, this allows the camera (for example the rear-facing camera) that is frequently installed in a communications terminal these days to be used to capture the 2-D images. This ensures good handling during the image capture.

In an alternative to bringing about a movement of the image capture device relative to the inspection object or in addition, the method may include bringing about a movement of the inspection object. To this end, one or more actuators may be driven in order to move the inspection object translationally and/or rotationally relative to the image capture device.

As a result, the images required to recognize the shape deviation may be obtained from different perspectives.

Bringing about the movement of the inspection object may include control functions that are dependent on the 3-D target geometry.

As a result, the inspection object may be subjected to such targeted movement that image capture may be implemented from several perspectives for each facet for which it should be possible to be able to detect a shape deviation.

For each facet of an outer envelope of the 3-D target geometry that is to be examined for shape deviations, the several 2-D images for which the back-projections are ascertained include at least two 2-D images that image this facet.

This may ensure that a shape deviation – if present – can be recognized from the back-projections.

The at least two 2-D images that image a facet differ in terms of their pose, advantageously in respect of both their translational and their rotational coordinates relative to a coordinate system of the inspection object.

This may ensure that a shape deviation – if present – can be recognized from the back-projections.

The 2-D images may be captured in such a way that an illumination of the inspection object relative to the inspection object remains locally unchanged while a relative pose between a camera used for image capture purposes and the inspection object changes between the capture of different 2-D images.

As a result, shadow-casting effects are substantially canceled out during the comparison of the back-projections.

The 2-D images may be captured in such a way that one or more illumination sources that are arranged stationarily relative to the inspection object are used for the illumination of the inspection object.

As a result, shadow-casting effects are substantially canceled out during the comparison of the back-projections if the camera is moved relative to the inspection object for the purpose of capturing the 2-D images.

The one or more illumination sources may be configured in such a way that they create an illumination that differs from a structured illumination, for example a volumetric emission.

As a result, the shape deviation recognition may be performed with little setup outlay.

The comparison may include determining a difference image between two back-projections onto at least one facet of the 3-D target geometry.

As a result, whether the back-projections deviate from each other, and optionally the strength of this deviation, may be ascertained pixel-by-pixel for the at least one facet that is depicted in at least two of the 2-D images.

The comparison of the back-projections may take account of the fact that the determination of the back-projections may include an interpolation of image pixels during the back-projection in order to allow comparability of the back-projections. Perspective and perspective resolution of an individual facet are generally different in the 2-D images. This may be taken into account by the interpolation.

This facilitates a comparison if perspective and perspective resolution of an individual facet are different in the 2-D images.

The comparison may include determining a distribution of pixel values in two or more than two back-projections onto at least one facet of the 3-D target geometry.

As a result, whether the back-projections deviate from each other, and optionally the strength of this deviation, may be ascertained pixel-by-pixel for the at least one facet that is depicted in at least two of the 2-D images.

The method may include preprocessing of the 2-D images and/or of the back-projections by the at least one processing circuit before the comparison is performed.

This may reduce possible disturbance effects that could adversely influence the shape deviation recognition.

The preprocessing may include one, more or all of the following preprocessing actions: reduction of instances of mirroring and/or reflection; compensation of brightness variations and/or shadows; selection and weighting of 2-D images on the basis of an image quality (for example, on the basis of sharpness, contrast and/or other quality features) and/or pose quality; refocusing and/or compensation of movements.

This may reduce possible disturbance effects that could adversely influence the shape deviation recognition.

The recognized shape deviation may include a shape deviation that is caused by a faulty manufacturing process for the inspection object, by a deformation of the inspection object post manufacturing or by a foreign body that has remained on the inspection object.

As a result, the method allows automated image-based recognition of various shape deviations.

According to a further aspect of the disclosure, a machine-readable command code is specified, the latter including machine-readable instructions that, upon execution by at least one processing circuit, prompt the at least one processing circuit to perform the method according to an aspect or embodiment.

The effects and advantages obtained by the machine-readable command code correspond to the effects and advantages explained with reference to the method.

According to a further aspect of the disclosure, a non-transitory storage medium with machine-readable command code stored thereon is specified, the latter including machine-readable instructions that, upon execution by at least one processing circuit, prompt the at least one processing circuit to perform the method according to an aspect or embodiment.

The effects and advantages obtained by the non-transitory storage medium correspond to the effects and advantages explained with reference to the method.

According to a further aspect of the disclosure, an apparatus or a system for recognizing a shape deviation of an inspection object from a 3-D target geometry in 3-D is specified. The apparatus or the system includes at least one processing circuit that is configured to determine a respective back-protection onto at least a part of the 3-D target geometry for several 2-D images of the inspection object and to undertake a comparison of the back-projections determined for the several 2-D images in order to recognize the shape deviation.

The effects and advantages obtained by the apparatus or the system correspond to the effects and advantages explained with reference to the method.

The apparatus or the system may further include a camera for capturing the several 2-D images.

The camera may be provided in a movable image capture device. The movable image capture device may be moveable relative to the inspection object in order to obtain 2-D images from several different perspectives for the evaluation.

This allows image recordings to be obtained from different perspectives by virtue of the image capture device with the camera being moved relative to the inspection object.

The camera may be provided in an image capture device that takes the form of a handheld device. The hand-held device may be movable relative to the inspection object in order to obtain the 2-D images from several different perspectives for the evaluation.

This allows the 2-D images to be captured easily, for example by virtue of the handheld device being moved relative to the inspection object by a human user or by way of using controllable actuators.

The apparatus or the system may be configured for a transfer of the 2-D images from the camera to the at least one processing circuit. The transfer may be wired or wireless, for example via a communications interface.

This allows the evaluation of the 2-D images for the recognition of the shape deviation to be carried out by a computing device that differs from the handheld device.

At least some of the evaluation may also be implemented in the handheld device, wherein the remaining evaluation steps may be performed in the computing unit.

The handheld device may include a wireless communications interface. For example, the handheld device may be configured as a communications terminal, for example, as a smartphone.

For example, this allows the camera (for example the rear-facing camera) that is frequently installed in a communications terminal these days to be used to capture the 2-D images. This ensures good handling during the image capture.

In an alternative to bringing about a movement of the image capture device relative to the inspection object or in addition, the apparatus or the system may be configured to bring about a movement of the inspection object relative to the camera. To this end, the apparatus or the system may include one or more controllable actuators in order to move the inspection object translationally and/or rotationally relative to the image capture device.

As a result, the images required to recognize the shape deviation may be obtained from different perspectives.

The apparatus or the system may include a controller for bringing about the movement of the inspection object; for moving the inspection object, the controller creates control signals on the basis of the 3-D target geometry.

As a result, the inspection object may be subjected to such targeted movement that image capture may be implemented from several perspectives for each facet for which it should be possible to be able to detect a shape deviation.

The apparatus or the system may include one or more illumination sources that are arranged stationarily relative to the inspection object for the purpose of illuminating the inspection object.

As a result, shadow-casting effects are substantially canceled out during the comparison of the back-projections if the camera is moved relative to the inspection object for the purpose of capturing the 2-D images.

The one or more illumination sources may be configured in such a way that they create an illumination that differs from a structured illumination, for example a volumetric emission.

As a result, the shape deviation recognition may be performed with little setup outlay.

The apparatus or the system may be configured to perform the method according to an aspect or embodiment. In this context, the processing steps and/or control steps may be carried out by the at least one processing circuit. Accordingly, the at least one processing circuit may be configured to carry out the steps explained in conjunction with optional features of the method.

The apparatus or the system may be configured to recognize a shape deviation that is caused by a faulty manufacturing process for the inspection object, by a deformation of the inspection object post manufacturing or by a foreign body that has remained on the inspection object.

As a result, the apparatus or the system allows automated image-based recognition of various shape deviations.

According to a further aspect of the disclosure, use of the method or the apparatus or the system according to an aspect or embodiment for the purpose of recognizing a faulty manufacturing process for the inspection object is provided. Depending on the recognition of the shape deviation, the manufacturing process may be temporarily halted and/or modified in order to rectify the shape deviation.

According to a further aspect of the disclosure, use of the method or the apparatus or the system according to an aspect or embodiment for the purpose of recognizing a deformation of the inspection object post manufacturing is provided. Depending on the recognition of the shape deviation, the inspection object may be rejected or modified.

According to a further aspect of the disclosure, use of the method or the apparatus or the system according to an aspect or embodiment for the purpose of recognizing a foreign body that has remained on the inspection object is provided.

Depending on the recognition of the shape deviation, the foreign body may be removed.

The methods, apparatuses and systems allow the determination of both positive shape deviations and negative shape deviations.

The methods, apparatuses, systems and system components according to embodiments of the disclosure achieve various consequences and effects. In particular, a detection of a shape deviation is rendered possible, wherein the setup outlay is kept low. Processing by the processing circuit can be carried out efficiently (specifically by determining and comparing back-projections of captured 2-D images). Consequently, a result of the shape deviation detection may be provided quickly, for example in the form of a visualization by way of a human-machine interface on an image capture device used to capture the 2-D images.

### BRIEF DESCRIPTION OF DRAWINGS

The invention will now be described with reference to the drawings wherein:

FIG. 1 is a schematic illustration of a system according to an embodiment.

FIG. 2 shows the system with a first relative pose between camera and inspection object.

FIG. 3 shows the system with a further, second relative pose between camera and inspection object.

FIG. 4 is a flowchart of a method according to an embodiment.

FIG. 5 is a flowchart with a procedure that can be used in the method according to an embodiment.

FIG. 6 shows an actual geometry of an inspection object for the purpose of explaining embodiments.

FIG. 7 shows an 3-D target geometry for the inspection object in FIG. 6.

FIG. 8 shows a 2-D image of the inspection object for the purpose of explaining embodiments.

FIG. 9 shows a further 2-D image of the inspection object for the purpose of explaining embodiments.

FIG. 10 shows a back-projection of the 2-D image in FIG. 8.

FIG. 11 shows a back-projection of the 2-D image in FIG. 9.

FIG. 12 shows a comparison result of the back-projections of FIG. 10 and FIG. 11.

FIG. 13 shows a visualization of a result of the shape deviation recognition.

FIG. 14 shows a further visualization of a result of the shape deviation recognition.

FIG. 15 is a flowchart with a procedure that can be used in the method according to an embodiment.

FIG. 16 is a block diagram representation of a processing circuit of a system or an apparatus according to an embodiment.

FIG. 17 is a schematic illustration of a system according to an embodiment.

FIG. 18 is a block diagram representation of an image recording device of a system according to an embodiment.

FIG. 19 is a block diagram representation of an image recording device of an apparatus according to an embodiment.

FIG. 20 is a flowchart of a method according to an embodiment.

FIG. 21 is a flowchart of a method according to an embodiment.

FIG. 22 is a flowchart with a procedure that can be used in the method of FIG. 21.

FIG. 23 is a schematic illustration of a system according to an embodiment.

FIG. 24 is a schematic illustration of a system according to an embodiment.

FIG. 25 is a schematic illustration of a system according to an embodiment.

FIG. 26 is a schematic illustration of a system according to an embodiment.

FIG. 27 is a flowchart of a method according to an embodiment

FIG. 28 is a schematic illustration of a system according to an embodiment.

FIG. 29 is a schematic illustration of a 3-D target geometry.

FIG. 30 is a flowchart of a method according to an embodiment.

### DETAILED DESCRIPTION

The features of the embodiments can be combined with one another, unless this is expressly precluded in the following description.

Methods, apparatuses and systems according to embodiments enable the image-based detection of shape deviations between an actual geometry of an inspection object and a 3-D target geometry. In this case, back-projections of several 2-D images onto one or more surfaces of the 3-D target geometry are determined. The several 2-D images are captured from different perspectives, that is, for different poses of the camera relative to the inspection object. From deviations between the back-projections, it is possible to recognize that the actual geometry deviates from the 3-D target geometry, that is, a shape deviation is present.

As yet to be explained in detail below, the methods, apparatuses and systems according to the disclosure can recognize shape deviations with little setup outlay. Conventional cameras may be used for 2-D image capture. The 3-D target geometry may be present in different ways, for example as a CAD model, as a surface mesh or in any other form that at least defines an outer envelope of the inspection object.

The term "3-D target geometry" as used herein is to be interpreted broadly, to the effect that the 3-D target geometry in any case specifies a desired (that is, target) shape of an outer envelope of the inspection object. It is possible but not mandatory for the 3-D target geometry to also include further information, for example regarding components of the inspection object not visually perceivable from the outside and/or regarding materials or surface textures.

The 3-D target geometry may include several surfaces or facets. For any desired shape, possibly also a complex shape, the geometry of the outer envelope can be approximated by facets, for example in the form of a triangular mesh or by way of any other faceting. Each surface or facet may be plane.

The term facet denotes a portion of the 3-D geometry. The facet may be flat, that is, planar.

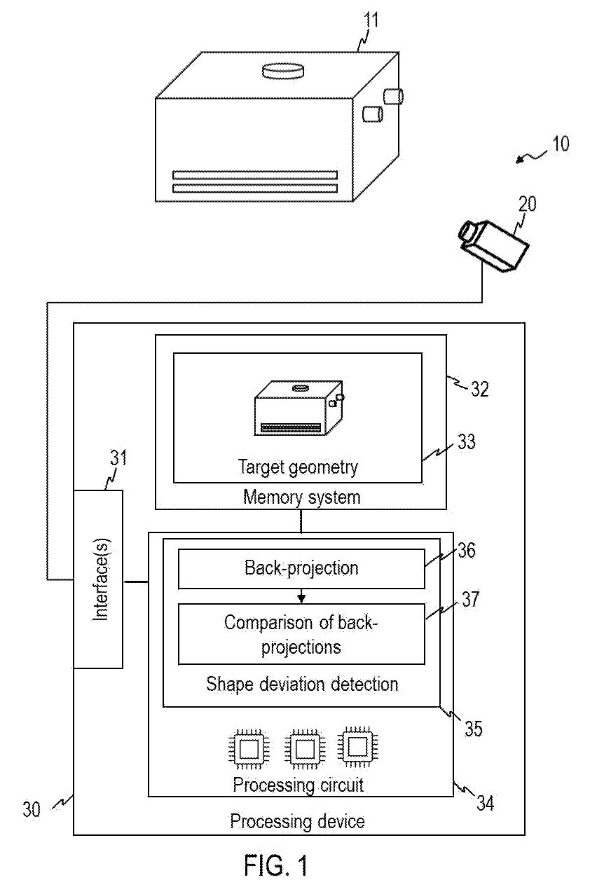

FIG. 1 shows a system 10 according to an embodiment. The system 10 is configured for image-based recognition of a shape deviation of an inspection object 11. The system 10 includes a camera 20 for capturing 2-D images of the inspection object 11 from several different perspectives (that is, in several different relative translational and/or rotational coordinates of the camera 20 relative to the inspection object 11).

The system 10 includes a processing circuit 34. The processing circuit 34 is configured to determine back-projections of several 2-D images onto one or more surfaces of the 3-D target geometry and compare the back-projections to one another. As a result, deviations between the back-projections can be found by the processing circuit 34. Such deviations between several back-projections that each cover the same surface or facet of the 3-D target geometry indicate a shape deviation of the actual geometry of the inspection object 11 from the 3-D target geometry.

The processing circuit 34 is configured to retrieve data that defines the 3-D target geometry 33 from a memory system 32. To determine the back-projections of 2-D images onto a surface of the 3-D target geometry, the processing circuit 34 uses pose information that defines the pose (in general three translational coordinates and three rotational coordinates) of the camera 20 relative to the inspection object 11. To determine the back-projections, the processing circuit 34 moreover uses camera parameters, in particular a camera matrix of the camera 20 or other data (in particular distortion parameters), that define the pixel of the camera 20 on which a world point is imaged. To determine the back-projections, the processing circuit 34 may moreover take distortion parameters in particular into account.

The back-projection can be implemented computationally efficiently by using the aforementioned data. A person skilled in the art is aware of techniques used to project a 2-D image onto surface(s) of a 3-D geometry (the 3-D target geometry in this case) by calculation. The intrinsic camera matrix defines the direction relative to the image sensor in which a respective pixel value was recorded. In combination with the 3-D target geometry, the pose defines the distance from the image sensor of the world point that corresponds to the pixel.

The processing circuit 34 is configured to carry out a shape deviation detection 35. By way of the shape deviation detection 35, the processing circuit 34 ascertains whether a shape deviation is present and optionally where this shape deviation is present. The shape deviation detection 35 includes the back-projection 36 of at least two 2-D images onto an identical surface of the 3-D target geometry 33 and a comparison 37 of the back-projections. The comparison 37 can be implemented in different ways, for example by determining a difference image of the back-projections (with the difference being established between the surface(s) of the inspection object represented in the two back-projections) or by determining a distribution, variance or any other measure of deviation for several back-projections.

A result of the shape deviation detection 35 is provided by the processing circuit 34. To this end, it is for example possible to control a human-machine interface (HMI) and/or a data interface on the basis of a result of the shape deviation detection 35.

The processing circuit 34 may be provided in a processing device 30 that is configured as a structural unit separate from the camera 20. The processing device 30 may include one or more interfaces 31 for receiving the 2-D images wirelessly or in wired fashion from the camera 20.

In a further configuration, the components of the processing device 30, or at least the processing circuit 34, may be integrated in a joint housing together with the camera 20, for example a housing of an image recording device or any other handheld device.

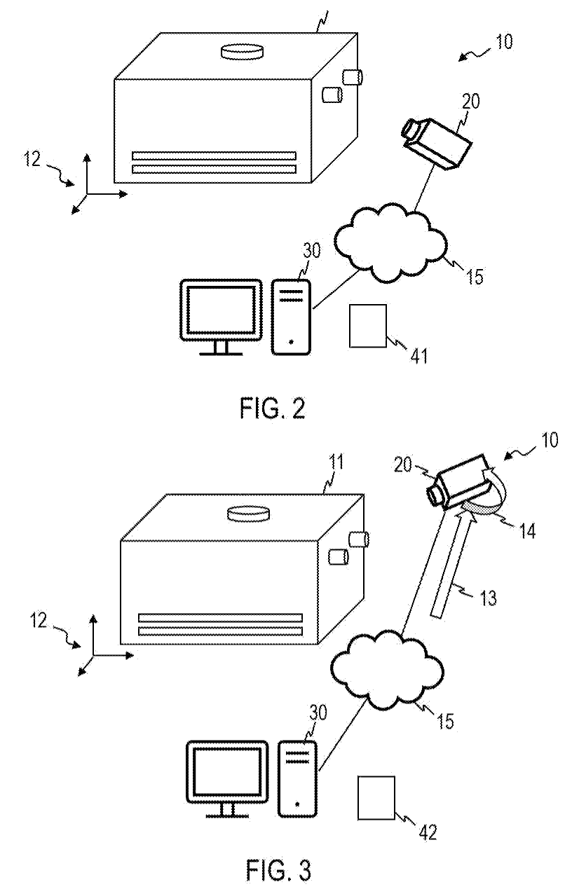

FIG. 2 and FIG. 3 show a system 1 according to an embodiment that includes the camera 20 and the processing device 30. The processing device 30 is configured to receive, via at least one data communications link (for example via a data communications link of a communications network 15), a first 2-D image 41 that is captured by the camera 20 when the latter is in a first pose relative to inspection object 11. The first pose may include three translational coordinates of a characteristic point of the camera (for example, the center of an image sensor) in a coordinate system 12 that is fixedly connected to the inspection object. The first pose may include three rotational

coordinates (for example, three Euler angles) that define the alignment of the camera 20 relative to the first coordinate system 20.

FIG. 3 illustrates that the processing device 30 is configured to receive, via the at least one data communications link, a second 2-D image 42 that is captured by the camera 20 when the latter is in a second pose, which differs from the first pose, relative to the inspection object 11. The second pose may differ from the first pose by a translational displacement 13 and a rotational movement 14 of the camera 20 relative to the first pose.

The first 2-D image 41 and the second 2-D image 42 both show at least one identical surface of the inspection object. The processing device 30 is configured to determine a first back-projection of the first 2-D image 41 onto the 3-D target geometry of the inspection object 11. Information about the first pose is used to this end. The processing device 30 is configured to determine a second back-projection of the second 2-D image 42 onto the 3-D target geometry of the inspection object 11. Information about the second pose is used to this end. The processing device 30 is configured to compare the first back-projection and the second back-projection in order to ascertain whether there is a shape deviation on a surface or facet of the inspection object 11 depicted in both the first 2-D image 41 and the second 2-D image 42.

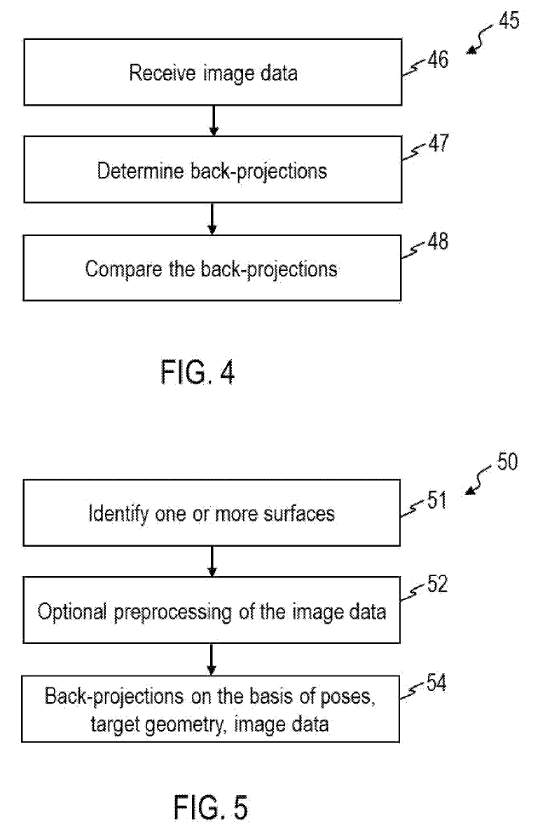

FIG. 4 is a flowchart of a method 45. The method 45 can be carried out automatically by the processing device 30 or by the processing circuit 34.

Image data are received at 46. The image data include 2-D images of the inspection object 11. The several 2-D images may be captured using a camera 20 that is installed in a handheld device. The several 2-D images include images that show an identical surface or facet of the inspection object 11. The several 2-D images include images that show the inspection object from different poses relative to the inspection object.

Back-projections of several 2-D images from among the received 2-D images are ascertained at 47. In this case, the back-projections may be ascertained in a manner dependent on the pose of the camera 20 relative to the inspection object during the

capture of the corresponding 2-D image, an intrinsic camera matrix of the camera 20 and the 3-D target geometry.

The back-projections are compared at 48. In this case, deviations are ascertained between 2-D images that were back-projected onto an identical surface of the 3-D target geometry. The ascertainment of the deviations may include determining a difference image, a pixel-by-pixel determination of a variance or a distribution or any other pixel-resolved determination of deviations between back-projections.

It is possible to provide a result of the comparison that specifies whether shape deviations are present and, if so, where. This may include controlling an HMI or a data interface. A manufacturing process may be controlled and modified on the basis of the comparison result. In an alternative to that or in addition, information relating to where the shape deviation is present on the inspection object may be provided on the basis of the comparison result. In an alternative to that or in addition, information relating to where a foreign body remained on the inspection object may be provided on the basis of the comparison result.

FIG. 5 is a flowchart of a procedure 50 that may be carried out to implement step 47 of the method 45. The procedure 50 may be carried out automatically by the processing device 30 or the processing circuit 34.

One or more surfaces or facets of the inspection object imaged in at least two of the 2-D images received are identified at 51. These surfaces or facets may be identified on the basis of the 3-D target geometry and the relative poses between the camera 20 and the inspection object present during the image capture.

Optional preprocessing of the image data may be implemented at 52. The optional preprocessing may include a reduction of possible disturbance effects, for example by way of suitable filtering. For example, light reflections may be reduced during the pre-processing. The preprocessing may include one, more or all of the following preprocessing actions:

reduction of instances of mirroring and/or reflection;

compensation of brightness variations and/or shadows;

selection and weighting of 2-D images on the basis of an image quality (for example, on the basis of sharpness, contrast and/or other quality features) and/or pose quality;

refocusing and/or compensation of movements.

The back-projections are determined on the basis of the poses, the 3-D target geometry and the intrinsic camera matrix at 54 in order to back-project the 2-D images onto surfaces or facets of the 3-D target geometry.

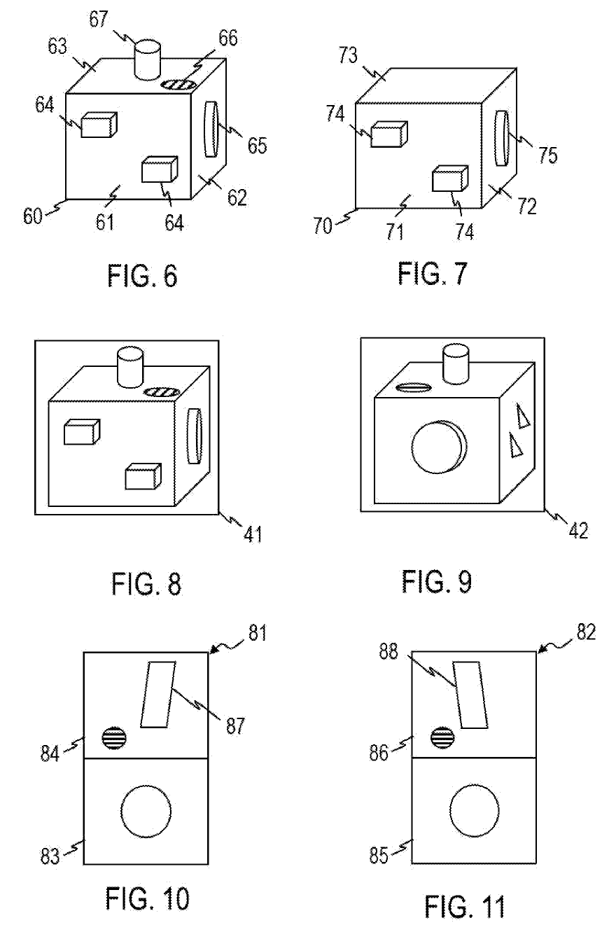

The functionality of the processing circuit 34 and of methods according to the embodiments is explained in detail and illustrated with reference to FIG. 6 to FIG. 14 on the basis of geometries and 2-D images.

FIG. 6 shows an actual geometry 60 of an inspection object. The inspection object includes several side faces 61, 62, 63. Protrusions 64 may be formed on a first surface 61. A protrusion 65 may be formed on a further surface 62. A protrusion 67 may be formed on an even further surface 63. The even further surface 63 may moreover, for example, include a distinct region 66 in terms of color or its texture.

FIG. 7 shows the 3-D target geometry 70 of the inspection object in fashion. The 3-D target geometry 70 defines the side faces 71, 72, 73. The 3-D target geometry 70 defines protrusions 74 that are formed on a first surface 71 of the 3-D target geometry. The 3-D target geometry 70 defines a protrusion 75 that is formed on the further surface 72. In this respect, the actual geometry for the surfaces 61, 62 corresponds to the 3-D target geometry of the corresponding surfaces 71, 72 in the case of the illustrated configurations. However, the even further surface 73 does not include a protrusion according to the 3-D target geometry 70. Hence the protrusion 67 represents a deviation between the actual geometry and the 3-D target geometry.

By way of example, FIG. 8 shows a first 2-D image 41 of the inspection object that images the surfaces 61, 62 and 63. By way of example, FIG. 9 shows a further 2-D image 42 of the inspection object that depicts the surfaces 62 and 63 and an additional surface, which is concealed in the perspective of FIG. 6. The 2-D images 41 and 42 differ

in terms of the relative pose between the camera 20 and the inspection object, in this case both in respect of the translational pose and the rotational alignment in particular.

FIG. 10 shows a first back-projection 81. The first back-projection 81 is obtained by projecting the first 2-D image 41 onto the 3-D target geometry 70. To simplify matters, only the back-projection onto the surfaces 72 and 73, which are visible in both the first 2-D image 41 and the second 2-D image 42, is illustrated. In the first back-projection 81, the shape deviation 67 of the actual geometry is back-projected into a region 87. The region 87 is located on a surface or facet 84 that is assigned to the surface 73 of the 3-D target geometry 70. Similarly, the back-projection onto the surface 72 of the 3-D target geometry 70 leads to a projection 83 of the first 2-D image 41 onto this surface or facet being obtained.

FIG. 11 shows a second back-projection 82. The second back-projection 82 is obtained by projecting the second 2-D image 42 onto the 3-D target geometry 70. To simplify matters, only the back-projection onto the surfaces 72 and 73, which are visible in both the second 2-D image 42 and the second 2-D image 42, is illustrated. In the second back-projection 82, the shape deviation 67 of the actual geometry is back-projected into a region 88. The region 88 is located on a surface or facet 86 that is assigned to the surface 73 of the 3-D target geometry 70. Similarly, the back-projection onto the surface 72 of the 3-D target geometry 70 leads to a projection 85 of the second 2-D image 42 onto this surface or facet being obtained.

As already evident from FIG. 10 and FIG. 11, the projection surfaces 83, 85 are consistent with each other. However, inconsistencies caused by the projection of the protrusion 67, which is visible in the 2-D images 41, 42, onto the surface 73 of the 3-D target geometry 70 are present on the projection surfaces 84, 86.

To quantify and locate the deviation in shape of the inspection object from the 3-D target geometry, it is possible to quantitatively compare the back-projections. For example, a difference image, a pixel-by-pixel variance or a pixel-by-pixel distribution of the back-projections may be ascertained to this end.

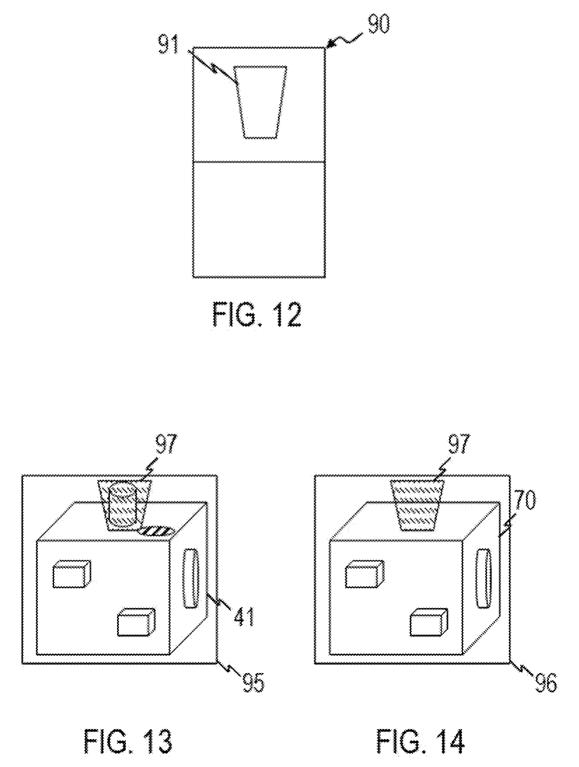

By way of example, FIG. 12 shows a difference image 90 that is obtained by pixel-by-pixel subtraction of the back-projections 81 and 82 in FIG. 10 and FIG. 11, respectively. The comparison of the back-projections takes into account the fact that the determination of back-projections 81, 82 may require an interpolation of pixels in the back-projection to benefit the comparability thereof. Perspective and perspective resolution of an individual facet are generally different in the 2-D images 41, 42. This may be taken into account by the interpolation. This facilitates a comparison if perspective and perspective resolution of an individual facet are different in the 2-D images 41, 42.

The differences between the back-projections 81 and 82 caused by the shape deviation 67 lead to the difference image 90 having nonzero pixel values (that is, nonzero differences between the back-projections) in a region assigned to the first surface 63. A corresponding region 91 in which an absolute value of the difference image is nonzero indicates that the shape deviation 67 is present on the surface 63 of the actual geometry or the surface 73 of the 3-D target geometry.

The result of the ascertainment whether a shape deviation is present and the result of locating the shape deviation may be used in different ways. For example, a human-machine interface may be controlled in such a way that, in respect of the inspection object, there is a display as to whether and optionally where a shape deviation is present between the actual geometry and the 3-D target geometry.

FIG. 13 and FIG. 14 show visualizations 95, 96 of the determined shape deviation. FIG. 13 shows a visualization in which the presence and the position of the shape deviation is depicted as an overlay 97 on one of the 2-D images 41. FIG. 14 shows a visualization 96 in which the presence and the position of the shape deviation is depicted as an overlay 97 on a reproduction of the 3-D target geometry 70.

Embodiments of the disclosure thus use a camera 20, for example, the camera installed in a smartphone or any other communications terminal, for example a tablet. This camera 20 is used to record images, which may be part of a video sequence, from different directions with a view of the inspection object. In the images, the inspection object is recognized and the pose (translation and orientation) between camera and object is determined.

In order to detect the shape deviation, the processing circuit 34 projects the digital 2-D image recordings of the actual state back onto the 3-D target geometry as a texture during the digital processing. The overlay from different perspectives is always perfectly consistent when the actual geometry corresponds to the 3-D target geometry. By contrast, the digital back-projections do not fit together when a 3-D shape deviation is present. The shape deviation may result from a missing component, an additionally installed component, an attachment on a component with the wrong shape or erroneous component alignment (translation or rotation) and/or one or more foreign bodies (for example, tools) on the inspection object. The evaluation is implemented on different individual facets of the 3-D target geometry that are imaged in at least two 2-D images. The evaluation may be implemented for each individual facet of the 3-D target geometry that is imaged in at least two 2-D images.

Since it is only the back-projected, perspective overlay that is processed as information from the real world, the result is largely independent of the appearance of the inspection object. In particular, the disclosed methods, apparatuses and systems are relatively robust vis-à-vis variations in the surroundings (brighter or darker surroundings) or inspection object illumination. The color or texture of the inspection object also plays a subordinate role because the color and texture information is canceled out in the evaluation of the differences between several back-projections for as long as the back-projection is self-consistent.

Merely the visibly perceivable outer 3-D envelope of the inspection object serves as a reference model (3-D target geometry). Individual components of the construction need not be separately addressable or need not be built apart virtually. As a result, it is also possible to use a digitized 3-D object (shape model without texture) as a reference, and this opens up novel applications (for example, in re-engineering or in computer-aided manufacturing). In particular, the application to shape models without texture is of particular practical importance.

The inspection result of this 3-D shape deviation is available as a 2-D difference image relating to all surfaces or facets of the 3-D target geometry. With false-color coding (for example, green – no deviation; red – strong deviation of the perspective back-projection), the view from different perspectives allows quick estimation as to the regions in which deviations are present.

A further advantage of the methods, apparatuses and systems consists in the fact that the evaluation of already available 2-D images may be implemented in parallel with (further) data acquisition. Additional 2-D images (for example, from a continuation of an image sequence or a further image sequence) may be added to the evaluation in order to improve or complement the result with additional perspectives (back side, detailed recording of individual regions).

A further advantage of the methods, apparatuses and systems consists in the fact that the setup outlay is low. Only the 3-D envelope of the inspection object needs to be present as a reference model (3-D target geometry). Further utilized data, for instance calibration parameters of the camera 20 (camera matrix and/or distortion parameters), may be determined once for the camera 20 employed and may be stored in non-transitory fashion.

The poses of the camera 20 relative to the inspection object (for example relative to the coordinate system 12), which are also used to determine the back-projections, may be determined in image-based fashion. In an alternative to that or in addition, sensor data may be used in order to determine the poses (in particular all six degrees of freedom of the pose). From the calibration parameters of the camera in combination with the poses, the 2-D images may be back-projected as a texture onto the individual facets or surfaces of the 3-D target geometry. In this context, a region of the 2-D image is wrapped onto the corresponding facet or surface, with the assignment of pixel of the 2-D image to pixel of the back-projection being implemented on the basis of the calibration parameters of the camera (in order to determine the direction of the world point in relation to the camera) and on the basis of the pose and the 3-D target geometry (in order to determine the position of the world point along the beam direction).

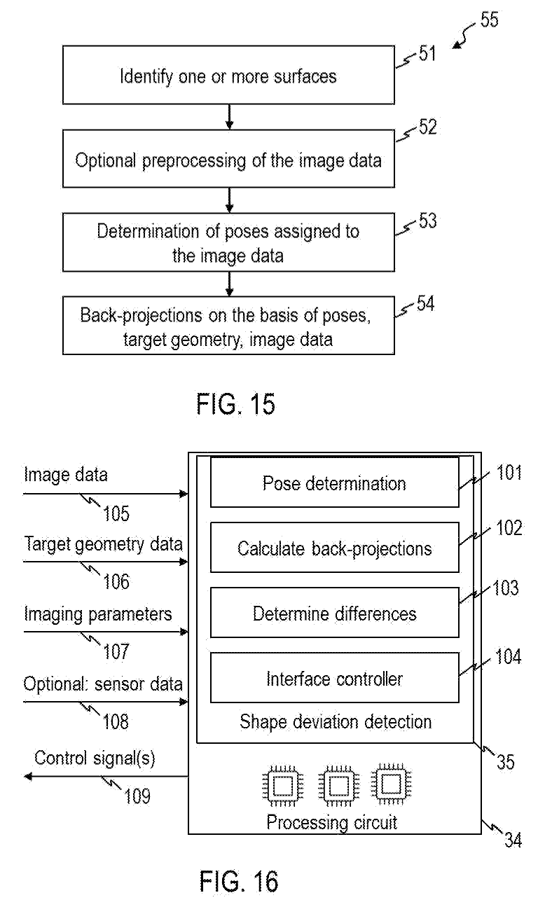

FIG. 15 is a flowchart of a method 55 that can be carried out automatically by the processing device 30 or the processing circuit 34. Processing steps explained with reference to FIG. 4 will not be explained again.

The method 55 includes a determination 53 of poses assigned to the 2-D images. At 54, the back-projections are determined on the basis of the poses determined thus.

The poses may be determined in image-based fashion. In the process, the 2-D images may be registered in view of the 3-D target geometry. The calibration parameters of the camera may be taken into account computationally in order to determine which 2-D image is assigned to which pose.

Sensor data may be used in the determination of the pose. For example, it is possible to use a position sensor (for example a GNSS sensor, for example, a GPS or Galileo sensor), an acceleration or direction sensor and/or any other sensors that are installed in a handheld device including the camera 20 in order to determine the poses or changes in the pose between 2-D images.

FIG. 16 shows a block diagram representation of the processing circuit 34. For the shape deviation detection 35, the processing circuit 34 may carry out a determination of pose in order to determine the relative poses between camera and inspection object for the 2-D images. The pose determination may be implemented on the basis of the 2-D images 105 in combination with 3-D target geometry data 106. When determining the pose 101, it is also possible to use imaging parameters 107, in particular calibration parameters for the camera 20. Optionally, sensor data 108 acquired by sensors of the handheld device housing the camera 20 and/or a different positioning system thereto may be used for determining the pose 101.

The back-projections 102 are calculated on the basis of the 2-D images 105, the 3-D target geometry 106 and the imaging parameters 107, and the respective poses determined for the 2-D images.

Differences between back-projections onto the same individual facets or surfaces of the 3-D target geometry may be determined 103 by subtraction or any other determination of a distribution or variance between the back-projections. In the process there is a spatially resolved ascertainment as to which individual surfaces or individual facets of the 3-D target geometry have inconsistencies between the back-projections.

An interface controller 104 is configured to create and adjust one or more control signals 109 on the basis of the ascertained differences between back-projections. The one or more control signals 109 may serve to control a human-machine interface. In an alternative to that or in addition, the one or more control signals 109 may bring about a control function via which a manufacturing process, for example, is influenced in response to a recognized shape deviation.

The human-machine interface, which is capable of visualizing a recognized shape deviation, may be integrated into the processing device 30 or provided remotely from the latter.

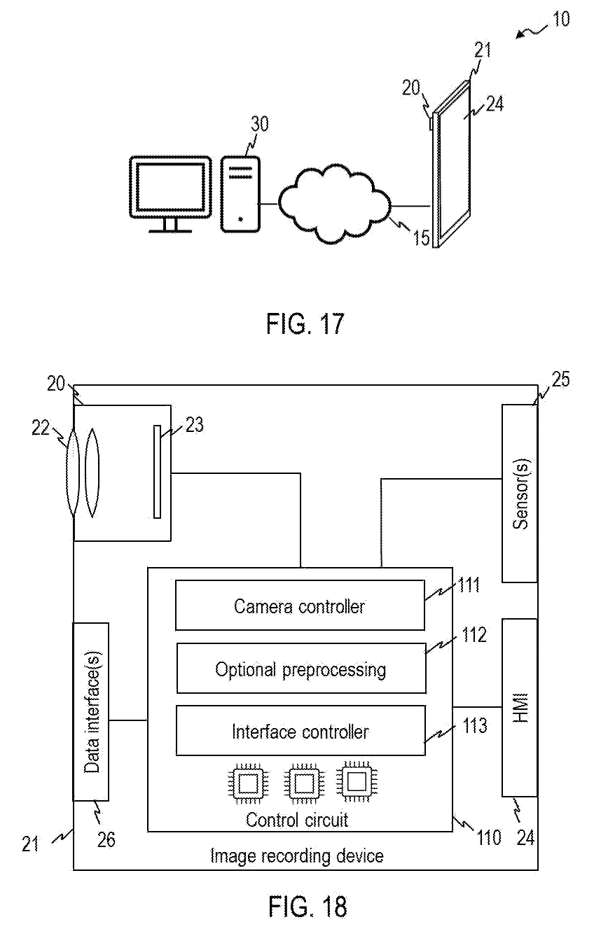

FIG. 17 shows a configuration of the system 10 in which the camera 20 is provided in a communications terminal in the form of a handheld device 21. The handheld device 21 also includes the human-machine interface 24. A result from the shape deviation detection is transferred from the processing device 30 and via a data communications link to the handheld device 21 and output there by way of the human-machine interface 24.

FIG. 18 shows a block diagram representation of an image recording device in the form of a handheld device 21. The image recording device includes the camera 20 with an imaging optics unit 22 and a camera chip 23. The image recording device 21 includes one or more data interfaces 26 in order to make captured 2-D images available to the processing device 30. The image recording device includes the human-machine interface 24 in order to output a result of the shape deviation detection.

The image recording device may optionally include one or more sensors 25 that capture data useful in the determination of the pose of the image recording device. For example, the one or more sensors 25 may include position sensors and/or direction sensors and/or motion sensors. The data acquired by the one or more sensors 25 may be made available to the processing device 30 via the data interface(s) 26, for example as metadata for the 2-D images or in any other way that allows an assignment of the sensor data to the 2-D images.

The image recording device includes a control circuit 110. The control circuit 110 may include one or more integrated circuits, for example processors, application-specific integrated circuits, controllers, field-programmable gate arrays and/or other integrated semiconductor circuits. The control circuit 110 may include a camera controller 111 for controlling an image capture by the camera 20. The control circuit 110 may include optional preprocessing 112 for the captured 2-D images prior to the output thereof via the data interface 26. The control circuit 110 may include an interface controller 113 in order to control the data interface 26 for the provision of the 2-D images. In an alternative to that or in addition, the interface controller 113 may be configured to control the human-machine interface 24 on the basis of a result of the shape deviation detection by the processing device 30 received via the data interface 26.

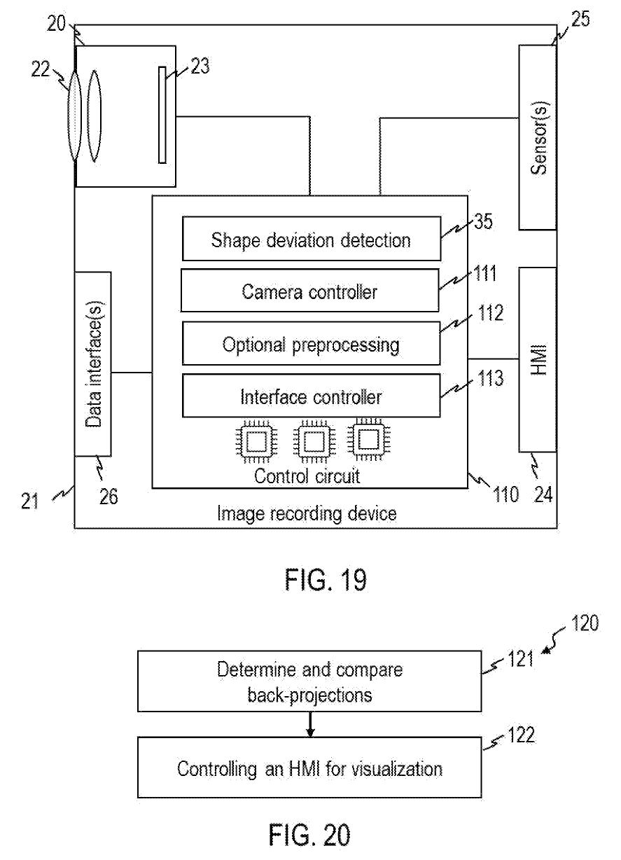

FIG. 19 shows a modification in which the image recording device is configured such that the control circuit 110 carries out the shape deviation detection 35. The result of the shape deviation detection 35 may be output locally at the human-machine interface 24. The result of the shape deviation detection may be output via the at least one data interface 26, for example for storage and/or for use within the scope of a rectification of the shape deviation.

FIG. 20 is a flowchart of a method 120 that can be carried out automatically by the processing device 30 or the processing circuit 34. In the method 120, the result of the shape deviation detection is used to control a human-machine interface. The human-machine interface may be provided remotely from the processing device 30 and in a manner integrated into a handheld device that also includes the camera 20.

At 121, the processing circuit determines several back-projections of 2-D images onto surfaces or facets of a 3-D target geometry. As a result, the 2-D images are wrapped onto the surfaces or facets as texture. At 121, the back-projections are compared to one another in order to identify inconsistencies that are caused by a shape deviation present.

At 122, a human-machine interface is controlled in order to visualize the shape deviation in relation to the inspection object. For example, the visualization can be implemented as an overlay on one of the captured 2-D images or as an overlay on a representation of the 3-D target geometry.

Even though an output and use of the detection result by way of visualization of the shape deviation was explained in fashion, the result may also be used in a different way in order to provide feedback regarding the shape deviation present and/or make further use of the ascertained information about the shape deviation present.

The methods, apparatuses and systems may use (fused) motion sensing 25 for facilitating and/or stabilizing pose determination. For example, explicit fusing with acceleration sensor data and/or depth image data may be implemented to this end. In an alternative to that or in addition, there may be indirect use by devices that support AR ("augmented reality"), for example communications terminals such as a smartphone or tablet.

In the methods, apparatuses and systems, use can be made of a handheld device with a display as a human-machine interface 24 for visualizing the shape deviation, for user guidance or for displaying regions that were already imaged by 2-D images.

In the methods, apparatuses and systems, the 2-D images may be recorded with the use of filters (for example color and/or polarization filters) in order to suppress disturbance effects. Luster, transparency or similar disturbance effects may thus be suppressed. In an alternative to that or in addition, the image may be recorded in a spectrally shifted range, for example in an IR or UV spectral range.

In the methods, apparatuses and systems, it is advantageous for the digital 3-D model of the visible envelope, that is, the 3-D target geometry, to have suitable scaling with respect to the real object. Should this not be the case, scaling may be implemented in order to facilitate the processing. Should the 3-D target geometry not be scaled correctly or sufficiently accurately, it may be sufficiently scaled or adjusted via a scaling method. For example, fused motion sensing may be used to this end.

The data that define the 3-D target geometry may include one or more meshes for defining the external visible envelope. It is not necessary but possible for individual components to be separately addressable in the 3-D target geometry.

Preprocessing of the data that define the 3-D target geometry may be carried out in the methods, apparatuses and systems. The preprocessing may be implemented in such a way that the back-projections can be undertaken as computationally efficiently as possible. For example, there may be a conversion into a representation as a mesh or as several meshes of suitable sizes with suitable indexing of the surfaces or facets or meshes.

The methods, apparatuses and systems may be configured in such a way that there is an intelligent image recording of the 2-D images and/or an image data reduction. This may include one, more or all of the following measures: removing or repairing poor quality image data (for example, compensated by image information from adjacent 2-D images in a sequence); selective triggering of an image recording once there was a minimum rotational and/or translational movement relative to the last recorded image. For the latter measure, the movement may be ascertained on the basis of the additional sensor 25 or the additional sensors 25.

The methods, apparatuses and systems may be configured in such a way that captured 2-D images are processed and intermediate results of the shape deviation detection are visualized or used in any other way while yet further 2-D images are captured.

The methods, apparatuses and systems may be configured in such a way that an intermediate result and/or a final result of the shape deviation detection is visualized from different perspectives.

The methods, apparatuses and systems may be configured in such a way that the visualization is implemented as augmentation from the current perspective of the user or of the handheld device in spatial relation with the inspection object.

The methods, apparatuses and systems may be configured in such a way that additional 2-D images or image sequences of 2-D images are received and processed in order to improve the result or supplement additional views (for example, back side).

The methods, apparatuses and systems may be configured in such a way that the image capture is guided or controlled. This may be advantageous for complex geometries in particular. In this case, desired observation poses are calculated by the processing circuit 34 or the processing device 30. These may be used to guide a user to the effect of adopting these or similar camera perspectives. In an alternative to that or in addition, actuators may be controlled in order to position the camera and the inspection object in a desired relative pose with respect to each other.

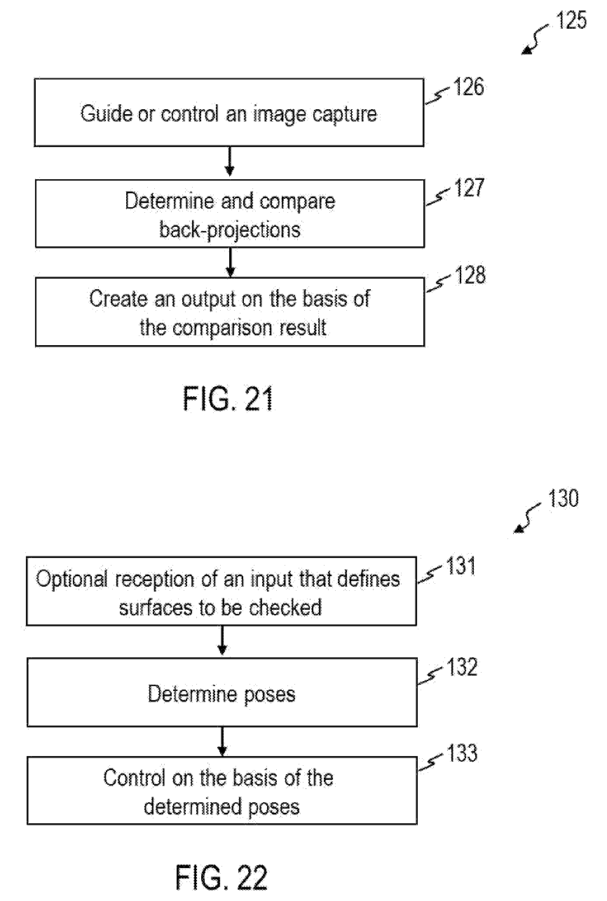

FIG. 21 is a flowchart of a method 125. The method 125 may be carried out automatically by the system 10.

At 126, the image capture of the 2-D images is guided or controlled under processing circuit 34 control. To this end, it is possible to ascertain desired poses from which the inspection object is to be captured using the camera 20. Guiding the image capture may include a generation and output of instructions to a user of the handheld device 21. The instructions may depend on the current pose of the handheld device 21.

At 127, the captured 2-D images are wrapped onto surfaces or facets of the 3-D target geometry as texture in order to ascertain the back-projections. The back-projections are compared surface-by-surface or facet-by-facet in order to ascertain whether and optionally where a shape deviation is present.

At 128, an output that is based on a result of the comparison of the back-projections is created. The output may include a visualization of the detected shape deviation and/or control signals for carrying out a control function.

FIG. 22 is a flowchart of a procedure 130. The procedure 130 may be carried out automatically by the system 10 in order to implement step 126 of the method 125.

At 131, a human-machine interface may optionally be controlled in such a way that an input is rendered possible, the latter defining surfaces that are to be checked for the presence of shape deviations.

At 132, the processing circuit 34 may determine poses in which an image is to be recorded, the determination being based on the defined surfaces and the 3-D target geometry. This may be implemented in such a way that each of the defined surfaces is imaged on at least two 2-D images.

At 133, the processing circuit 34 may carry out a control function that depends on the determined poses. As a result of the control function, a user of the handheld device 21 may be guided in the image recording. In an alternative to that or in addition, the control function may control or regulate one or more actuators in order to realize the desired relative poses between the camera 20 and the inspection object.

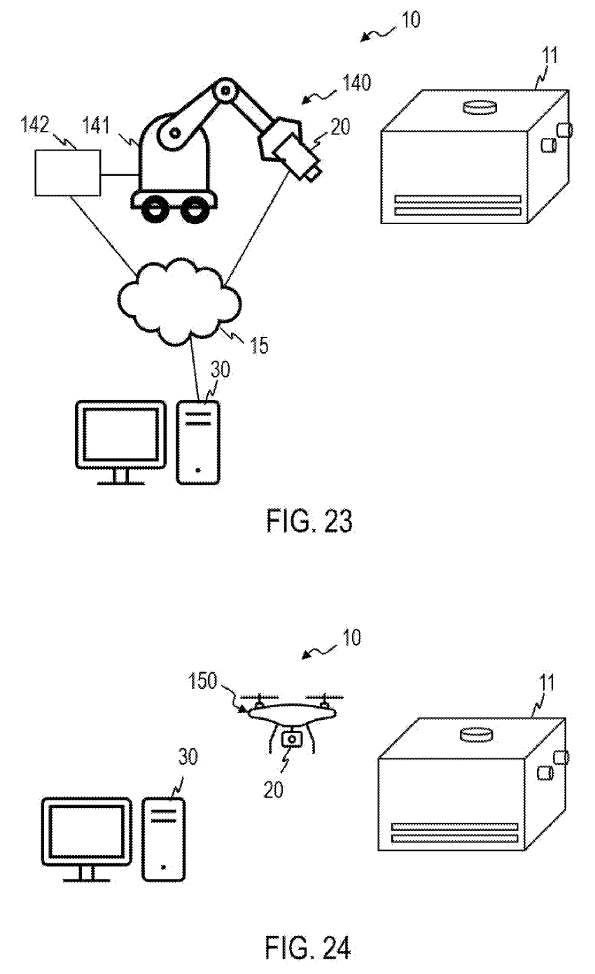

FIG. 23 and FIG. 24 show systems that are configured for the shape deviation detection according to the techniques disclosed in detail herein. The systems 10 in FIG. 23 and FIG. 24 each include one or more actuators, with the processing circuit 34 being configured to control the actuator or actuators in such a way that desired relative poses between the camera 20 and the inspection object 11 are realized.

FIG. 23 shows a system 10 including a robot 140. The robot 140 may include a movable robot base 141 and/or one or more further actuators 142 for positioning the camera 20. The robot 140 may include a multi-axis robotic arm that allows the camera 20 to be positioned in different alignments relative to the inspection object 11.

The processing of the captured 2-D images by the processing device 30 is implemented as already described in detail above.

FIG. 24 shows a system 10 including a controllable flying object 150. Under processing device 30 control, the controllable flying object 150 may position a camera 20 assembled on the flying object in desired relative poses with respect to the inspection object 11. The flying object 150 may include actuators that allow the camera 20 to be displaced relative to the flying object 150 and positioned in different alignments relative to the inspection object 11.

As already explained, the methods, apparatuses and systems according to embodiments require relatively little setup outlay. In particular, no structured illumination is required.

It is advantageous for an illumination source or several illumination sources for illuminating the inspection object 11 to maintain their position relative to the inspection object 11 when the 2-D images are captured. Such a configuration at least partially compensates for shadowing effects when the back-projections are compared with one another.

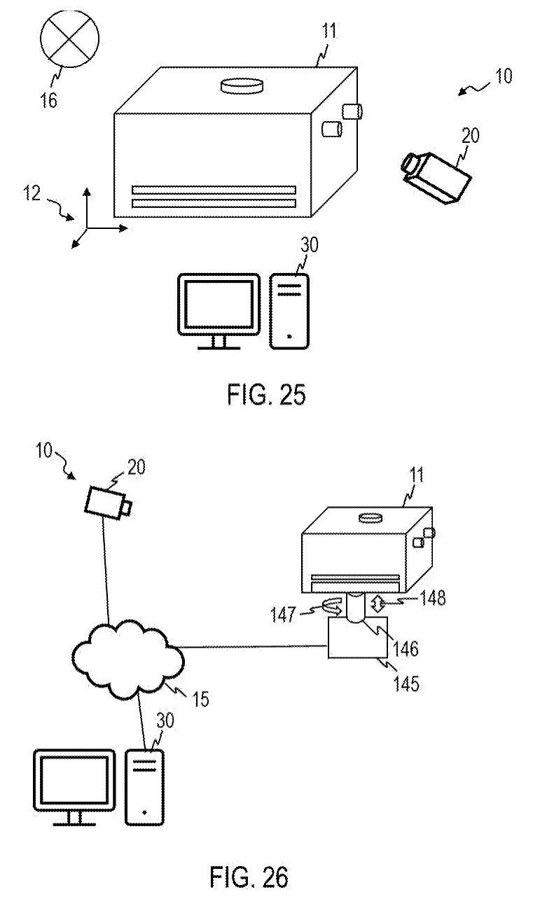

FIG. 25 is a schematic illustration of the system 10 according to an embodiment that includes one or more illumination sources 16 in addition to the camera 20 and the processing circuit 34 provided in a processing device 30. When the camera 20 moves relative to the inspection object 11, the one or more illumination sources 16 remain stationary in the coordinate system 12 of the inspection object 11.

Whereas configurations in which the camera 20 is moved and the inspection object 11 may remain stationary were described with reference to FIG. 2, FIG. 3, FIG. 23 and FIG. 24, the system 10 may, in an alternative to that or in addition, be configured in such a way that the inspection object 11 is moved translationally and/or rotationally.

FIG. 26 shows a system 10 according to an embodiment that includes one or more actuators 145, 146 in addition to the camera 20 and the processing device 30 with the processing circuit 34. The actuator or actuators 145, 146 are configured to bring about a translational movement 148 and/or a rotational movement 147 of the inspection object 11. The one or more actuators 145, 146 may be controlled by the processing device 30. Control can be implemented in such a way that each relevant surface or facet of the inspection object 11 is imaged in at least two, and optionally in more than two, 2-D images.

In all disclosed configurations, the method, the apparatus or the system may be configured to provide feedback to the user as regards the regions that were recorded without or with insufficient coverage via 2-D images. The processing device 30 may be configured to generate proposals or instructions and output these via the handheld device 21 in order to instruct the user as regards to where and how the handheld device is still to be moved or positioned.

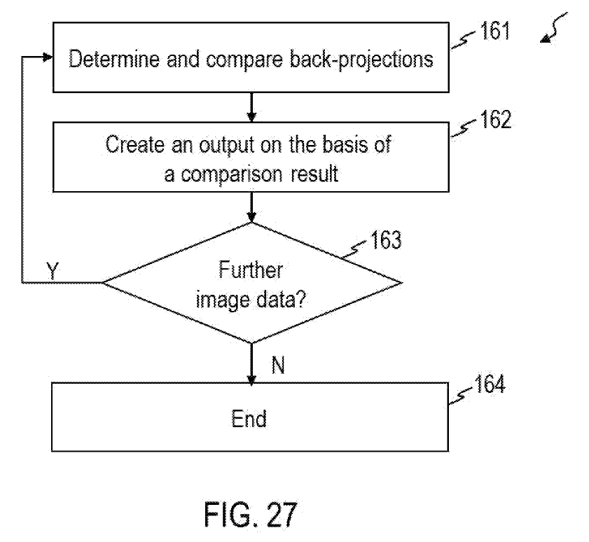

FIG. 27 is a flowchart of a method 160 that can be carried out automatically by the processing device 30 or the processing circuit 34. The method 160 may be used to output intermediate results, which are determined from a group of 2-D images, while further 2-D images are captured and processed in parallel.

As already explained, back-projections of 2-D images onto the 3-D target geometry are determined and compared to one another at 161 and 162. An output is created on the basis of a comparison result from the back-projections.

Further 2-D images may be captured in parallel with these steps 161 and 162.

A check as to whether the further 2-D images are available is performed at 163. Should further 2-D images be available, additional back-projections may be ascertained for them. In an alternative to that or in addition, there may be a check as to whether further image recordings are required or recommended, wherein the user may be instructed to capture further 2-D images by way of an output via a human-machine interface. The processing may be updated by virtue of further 2-D images being taken into account for already checked surfaces or facets of the 3-D target geometry and/or by virtue of the comparison of back-projections being carried out for further surfaces or facets for which no comparison result had been available previously.

As already mentioned, the data that define the 3-D target geometry may be available in a multiplicity of different forms. It may be advantageous to define the 3-D target geometry in such a way that the back-projections may be undertaken efficiently, and a multiplicity of different geometries are displayable at the same time. For the surface-by-surface or facet-by-facet ascertainment of the back-projections, it may be advantageous in particular to define the 3-D target geometry by a mesh. If the 3-D target geometry has originally been available in a different format, there may be a conversion into one or more meshes.

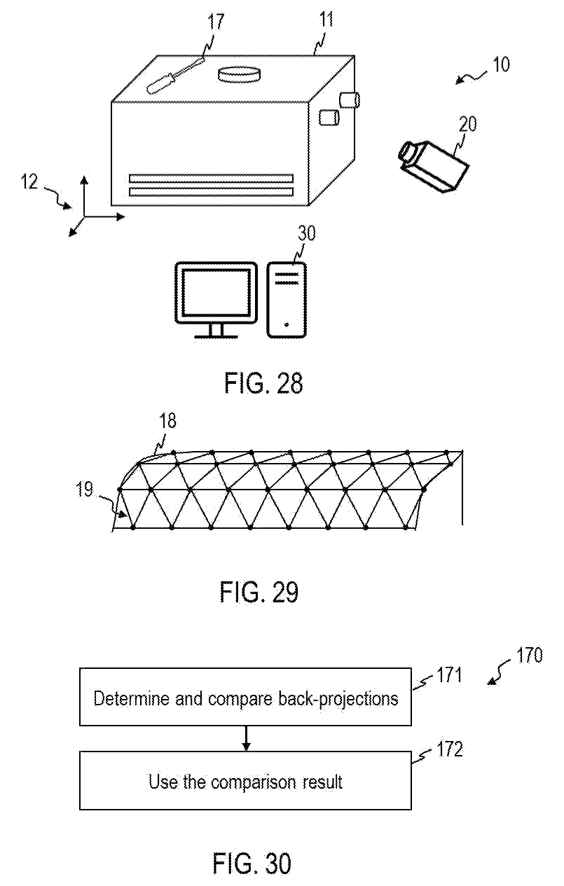

FIG. 28 shows an application of the disclosed apparatuses and methods. The apparatuses and methods may be used to recognize a shape deviation that results from a foreign body 17 (for example a tool 17) on the inspection object 11. Hence, the disclosed apparatuses and methods may be configured to recognize tools that remained on the inspection object 11, for example after maintenance work.

By way of example, FIG. 29 shows such a representation, in which a curved surface portion 18 of the inspection object is approximated by a mesh 19. The described techniques of back-projection and comparison of back-projections may be carried out in such a way that the 2-D images are in each case wrapped onto the different (typically plane) facets of the mesh and are then compared to one another facet by facet.

FIG. 30 is a flowchart of a method 170. In the method, several back-projections are determined and compared with one another at step 171, as already described above.

The method 170 includes a step 172 of using the comparison results. The use of the comparison results may include an identification of a shape deviation that may result from a missing component, an additionally installed component, an attachment on a component with the wrong shape or erroneous component alignment (translation or rotation) and/or foreign bodies (for example, tools) on the inspection object. The evaluation is implemented on one or more individual facets of the 3-D target geometry that are imaged in at least two 2-D images. Step 172 may include a removal of a foreign body 17 that remained on the inspection object 11, depending on the recognition of the shape deviation.

Optional additional or alternative features may be used in all disclosed methods, apparatuses and systems.

For image recording, the methods, apparatuses and systems may use a camera 20 that includes a stereo camera or a depth-image camera.

For image recording, the methods, apparatuses and systems may use a camera 20 that has a shifted spectral range (for example in the IR or UV range).

The camera 20 may be configured for monochrome or multispectral image recording. The comparison of the back-projections may be implemented separately for each of the image channels. A deviation of the back-projections in one of the image channels may already indicate a shape deviation.

For image recording, the methods, apparatuses and systems may use a camera 20 that is integrated into a communications terminal. The communications terminal may be a handheld device, for example a smartphone, a tablet or a laptop.

For image recording, the methods, apparatuses and systems may use a camera 20 that is fixedly installed or is moved in automated fashion. Configurations in which the camera has been attached to a measuring arm are also possible.

The methods, apparatuses and systems may be configured in such a way that, in an alternative to a movement of the camera 20 or in addition, a movement of the inspection object 11 may be brought about. To this end, the system 10 may for example include a rotary plate, on which the inspection object 11 is positioned.

The methods, apparatuses and systems may be configured in such a way that, in addition to the 3-D target geometry, more information about the inspection object is stored and used during the shape deviation detection. For example, this information may include: texture information (for example relating to color, luster, transparency, absorptance) resolution in individual components information with additional construction stages or integration phases of the inspection object.

The methods, apparatuses and systems may be configured in such a way that, in addition to a visualization on the handheld device 21 or in an alternative thereto, user guidance or feedback is provided in haptic form (for example, vibrations), in acoustic form (for example, different sounds) or on a separate optical output device.

The methods, apparatuses and systems may be configured in such a way that there is a reduction of processing in portions of the 3-D reference model in order to accelerate the method. For example, the back-projections may be selective for facets or surfaces of the 3-D target geometry if the geometric dimensions thereof reach or exceed a minimum size.

The methods, apparatuses and systems may be configured in such a way that there is an automatic calculation and implementation of the movement before and during the process if actuators are used to change the relative pose between camera 20 and inspection object 11.

The methods, apparatuses and systems may be used not only for detecting positive shape deviations (that is, in cases in which the surface of the inspection object is offset toward the camera 20 in comparison with the 3-D target geometry) but also for detecting negative shape deviations (that is, in cases in which the surface of the inspection object is arranged offset away from the camera 20 in comparison with the 3-D target geometry). The methods, apparatuses and systems may thus be configured for the detection of negative shape deviations.

A visualization of the shape deviation may indicate the presence of a shape deviation in spatially dependent fashion. For example, a heat map may be generated and output in order to indicate where a shape deviation is present. Different color codes may be used.

The methods, apparatuses and systems may be configured in such a way that the 2-D images are preprocessed. Preprocessing may be carried out in the handheld device 21 and/or in the processing device 30. The processing steps may be based on individual 2-D images or on the totality of 2-D images in order to exploit different perspectives.

Possible processing steps may include the following:

A reduction of instances of mirroring and reflection: For example, an additive model may be used to this end, the latter decomposing the image into a specular component or luster component and a diffuse component. A trained machine learning model, for example a trained neural network, may be used to separate the diffuse component from the luster component. The trained machine learning model may include an input for receiving the 2-D image. As output, the trained machine learning model may provide the diffuse component or the diffuse component and the luster image.

Compensation of brightness variations and shadows: Conventional analytic image processing methods may be used to this end. Histogram-based techniques are mentioned by way of example. It is also possible to use a trained machine learning model, as explained in the preceding bullet point.

A selection and weighting of the recordings on the basis of the image quality (sharpness, contrast, …) and/or pose quality: The pose quality may be ascertained by way of an evaluation that is based on the pose calculation and reflects the uncertainty of the ascertained pose. The image quality may be assessed on the basis of the image data (for example by recognizing instances of mirroring or poor histograms).

Refocusing and compensation of movement: To this end, motion blur may be reduced on the basis of the totality of the images.

Implementation details regarding such techniques are known to a person skilled in the art.

The 2-D images may include in particular 2-D images of an image sequence, for example a video sequence. Advantageously, the 2-D images may be captured while the camera 20 continuously changes its pose relative to the inspection object. In particular, this allows the 2-D images to be captured as images from a video sequence. A selection of suitable 2-D images from the image sequence may be implemented in view of the image quality, the quality of the pose determination and the required coverage of the facets or surfaces of the inspection object.

In an embodiment, the apparatus or the system is consequently used as follows:

i. The camera 20 is provided in a handheld device 21. The handheld device 21 is put into an operational state for capturing the 2-D images.

ii. The 2-D images are captured during a relative movement between handheld device 21 and inspection object 11. The 2-D images are provided in the processing circuit 34.

iii. The processing circuit 34 may select several of the 2-D images for the further processing. The processing circuit 34 determines the poses that are assigned to the several 2-D images. As described above, the selection may be implemented on the basis of quality criteria that relate to the 2-D images, the pose determination and/or the desired coverage of the inspection object.

iv. The several 2-D images are computationally back-projected onto the facets of the 3-D target geometry imaged therein (that is, wrapped as a texture onto the facets) by the processing circuit 34.

v. There may be a comparison of the back-projections by the processing circuit 34 for each facet for which at least two back-projections are available. This may include a quantification of the differences, for example by pixel-by-pixel subtraction (in the facet onto which the back-projection was implemented) or pixel-by-pixel ascertainment of a distribution or variance (in each case in the facet onto which the back-projection was implemented).

vi. An output dependent on the comparison result is created. This may include a control of the human-machine interface 24 for the purpose of visualizing the shape deviation.

vii. Feedback for the user may be generated and output, the feedback providing information about coverage with 2-D images already obtained and/or guiding or controlling further image capture. The feedback may also include the quality of the spatially resolved detection of the shape deviation already attained.

viii. Continued image recording and processing of the further 2-D images in order to improve the evaluation results may be rendered possible while a first group of 2-D images have already been processed.

As mentioned, the processing circuit 34 and the camera 20 may be realized in different structural units that are movable relative to one another or combined in a single piece of equipment. The processing circuit 34 may include one or more integrated circuits to carry out the required processing steps. The one or more integrated circuits may for example include any desired one or any desired combination of the following circuits or circuit components: an application-specific integrated circuit (ASIC), a field-programmable gate array (FPGA), a processor, a controller, one or more quantum gates, a circuit for quantum information processing, further integrated circuits.

While embodiments have been described with reference to the FIGS., modifications can be realized in further embodiments. Specific modifications and developments were already explained above. Further modifications are possible. For example, while a handheld device may be used for the capture of the 2-D images and optional preprocessing prior to the transfer of the 2-D images, other mobile devices, in particular portable devices, may also be used.

While a description has been given of embodiments which can be used in systems of industrial manufacturing or quality control, the disclosed techniques can also be used in other areas of application.

The present disclosure also encompasses embodiments with any combination of features that are specified or shown in relation to different embodiments. It also encompasses individual features in the FIGS., even if they are shown there in connection with other features and/or are not mentioned above or below. The alternatives of embodiments described in the FIGS. and the description and individual alternatives of their features can also be excluded from the subject matter of the disclosure or from the disclosed subject matter.

A machine-readable command code which can be executed by a programmable circuit for the purpose of carrying out methods according to embodiments can be stored and/or distributed on a suitable medium, such as for example on an optical storage medium or a solid-state medium, which is provided together with or as part of other hardware. The command code can also be distributed in other forms, for example in the form of a modulated data signal sequence.

Embodiments of the disclosure provide improved techniques for the image-based 3-D shape inspection that offer improvements in view of setup outlay and speed during the provision of inspection results in particular.

It is understood that the foregoing description is that of the preferred embodiments of the invention and that various changes and modifications may be made thereto without departing from the spirit and scope of the invention as defined in the appended claims.

1. A method for recognizing a shape deviation of an inspection object from a three-dimensional target geometry in three dimensions, the method comprising:
receiving two-dimensional images of the inspection object by at least one processing circuit;
determining several back-projections onto the three-dimensional target geometry by the at least one processing circuit, wherein a back-projection onto at least a part of the three-dimensional target geometry is determined for each of several of the two-dimensional images of the inspection object; and,
comparing the several back-projections determined for the several of the two-dimensional images via the at least one processing circuit in order to recognize the shape deviation.

2. The method of claim 1, wherein said comparing the several back-projections is carried out for each of several different facets of the three-dimensional target geometry.

3. The method of claim 1, wherein, on a basis of said comparing the several back-projections, the at least one processing circuit performs a spatially resolved ascertainment of regions in which an outer envelope of the inspection object deviates from an outer envelope of the three-dimensional target geometry.

4. The method of claim 1, further comprising providing an output on a basis of the recognized shape deviation.

5. The method of claim 4, wherein the output comprises a spatially resolved visualization of the recognized shape deviation.

6. The method of claim 1, wherein the several back-projections are determined on the basis of poses of an image capture device when capturing the two-dimensional images, wherein the method further comprises ascertaining the poses via the at least one processing circuit.

7. The method of claim 6, wherein said ascertaining the poses is achieved via at least one of:
one of the two-dimensional images, the three-dimensional target geometry and camera parameters of the image capture device used to capture the one of the two-dimensional images; and,
sensor data assigned to the one of the two-dimensional images.

8. The method of claim 1 further comprising:
reading three-dimensional target geometry data from a memory system; and,
creating a scaled model of an outer envelope of the three-dimensional target geometry on a basis of the read three-dimensional target geometry data by the at least one processing circuit, wherein the several back-projections are determined on a basis of the scaled model of the outer envelope.

9. The method of claim 1 further comprising selecting the several of the two-dimensional images from the received two-dimensional images by the at least one processing circuit.

10. The method of claim 1 further comprising:
receiving additional two-dimensional images by the at least one processing circuit; and,
comparing further back-projections onto the three-dimensional target geometry determined from the additional two-dimensional images in order to improve the recognition of the shape deviation.

11. The method of claim 1 further comprising creating control data or control signals by the at least one processing circuit for a purpose of controlling or guiding a capture of the two-dimensional images, wherein the at least one processing circuit uses the three-dimensional target geometry for the creation of the control data or control signals.

12. The method of claim 1, wherein the recognized shape deviation is caused by a faulty manufacturing process for the inspection object, by a deformation of the inspection object post manufacturing or by a foreign body that has remained on the inspection object.

13. A machine-readable command code for recognizing a shape deviation of an inspection object from a three-dimensional target geometry in three dimensions, the machine-readable code being stored on a non-transitory computer readable medium, the machine-readable code comprising machine-readable instructions that, upon execution by at least one processing circuit, prompt the at least one processing circuit to:
receive two-dimensional images of the inspection object by at least one processing circuit;
determine several back-projections onto the three-dimensional target geometry by the at least one processing circuit, wherein a back-projection onto at least a part of the three-dimensional target geometry is determined for each of several of the two-dimensional images of the inspection object; and,
compare the several back-projections determined for the several of the two-dimensional images via the at least one processing circuit in order to recognize the shape deviation.

14. An apparatus or system for recognizing a shape deviation of an inspection object from a three-dimensional target geometry in three dimensions, the apparatus comprising:
at least one processing circuit configured to:
determine a respective back-projection onto at least a part of the three-dimensional target geometry for several two-dimensional images of the inspection object; and,
undertake a comparison of the back-projections determined for the several of the two-dimensional images in order to recognize the shape deviation.

15. The apparatus or system of claim 14, further comprising:
an image capture device for capturing the several two-dimensional images.
